(19) United States
(12) Patent Application Publication
(10) Pub. No.: US 2026/0309399 A1
(43) Pub. Date: Oct. 8, 2026

(54) REFRIGERATOR APPLIANCE WITH LIQUID DRAIN ASSEMBLY

(71) Applicant: Haier US Appliance Solutions, Inc., Wilmington, DE (US)

(72) Inventors: Ronald Kenneth Anderson, Sidney, OH (US); Thomas French, Pewee Valley, KY (US)

(21) Appl. No.: 19/098,218

(22) Filed: Apr. 2, 2025

(51) Int. Cl. F25D 21/14; F16K 31/126

(52) U.S. Cl. CPC F25D 21/14; F16K 31/126

(57) ABSTRACT

A refrigerator appliance includes a cabinet defining a chilled chamber. Additionally, the appliance includes a door rotatably hinged to the cabinet. Furthermore, the appliance includes a sealed cooling system for providing cooled air into the chilled chamber. The sealed cooling system includes an evaporator. Moreover, the appliance includes a liquid drain assembly for the evaporator. The drain assembly includes an evaporator drip pan positioned below the evaporator for capturing dripping liquid. Additionally, the drain assembly includes a combination vacuum release drain valve that includes a main body. The main body includes a vacuum release valve and a drain flapper valve integrally coupled to each other. Furthermore, the drain assembly includes a tube fluidly coupled between the evaporator drip pan and the combination vacuum release drain valve, the tube by which fluid is permitted to flow from the evaporator drip pan to the combination vacuum release drain valve.

### FIELD

The present subject matter relates generally to refrigerator appliances, and more particularly to refrigerator appliances with liquid drain assemblies.

### BACKGROUND

Refrigerator appliances generally include a cabinet that defines chilled chambers for receipt of food items for storage. Insulated, sealing doors are provided for selectively enclosing the chilled food storage chambers.

Refrigerator appliances typically utilize sealed systems for cooling the chilled chambers. A typical sealed system includes at least one evaporator and a fan, and such refrigerator appliances usually include a separate evaporator for each chamber to achieve different temperatures in each of the chilled chambers. Such sealed systems also include a compressor which urges refrigerant through the sealed system, and the compressor may be a variable speed compressor where the operating speed of the compressor influences the rate of cooling provided to each chilled chamber from the respective evaporator.

Generally, it is undesirable for liquid, such as defrosted liquid, to gather or collect on components of the sealed system. Collection of liquid on components of the sealed system, such as the evaporator, can lead to operational inefficiencies of the sealed system.

Accordingly, refrigerator appliances with liquid drain assemblies for draining liquid from sealed systems would be beneficial.

### BRIEF DESCRIPTION

Aspects and advantages of the invention will be set forth in part in the following description, or may be obvious from the description, or may be learned through practice of the invention.

In one aspect of the present disclosure, a refrigerator appliance defining a vertical direction, a lateral direction, and a transverse direction is provided. The refrigerator appliance includes a cabinet. The cabinet defines a chilled chamber. Additionally, the refrigerator appliance includes a door. The door is rotatably hinged to the cabinet to provide selective access to the chilled chamber. Furthermore, the refrigerator appliance includes a sealed cooling system for providing cooled air into the chilled chamber. The sealed cooling system includes an evaporator. Moreover, the refrigerator appliance includes a liquid drain assembly for the evaporator of the sealed cooling system. The liquid drain assembly includes an evaporator drip pan. The evaporator drip pan is positioned below the evaporator for capturing liquid dripping from the evaporator. Additionally, the liquid drain assembly includes a combination vacuum release drain valve. The combination vacuum release drain valve includes a main body. The main body includes a vacuum release valve and a drain flapper valve integrally coupled to each other. Furthermore, the liquid drain assembly includes a tube fluidly coupled between the evaporator drip pan and the combination vacuum release drain valve, whereby fluid is permitted to flow from the evaporator drip pan to the combination vacuum release drain valve.

In another aspect of the present disclosure, a refrigerator appliance defining a vertical direction, a lateral direction, and a transverse direction is provided. The refrigerator appliance includes a cabinet. The cabinet defines a chilled chamber. Additionally, the refrigerator appliance includes a door. The door is rotatably hinged to the cabinet to provide selective access to the chilled chamber. Furthermore, the refrigerator appliance includes a sealed cooling system for providing cooled air into the chilled chamber. The sealed cooling system includes an evaporator and a condenser. Moreover, the refrigerator appliance includes a liquid drain assembly for the evaporator of the sealed cooling system. The liquid drain assembly includes a vaporizer pan. Additionally, the liquid drain assembly includes a combination vacuum release drain valve. The combination vacuum release drain valve includes a main body. Furthermore, the combination vacuum release drain valve includes a coupling arm. The coupling arm is integrally coupled to and protrudes from the main body. Moreover, the coupling arm is fastened to a portion of the vaporizer pan, whereby the combination vacuum release drain valve is rigidly coupled to the vaporizer pan.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to one or more example embodiments of the present disclosure.

FIG. 2 provides a perspective view of the example refrigerator appliance shown in FIG. 1, wherein refrigerator doors are in an open position according to one or more example embodiments of the present disclosure.

FIG. 3 provides a schematic view of various components of the example embodiments of FIG. 1.

FIG. 4 provides a perspective view of an example liquid drain assembly for use with various refrigerator appliances, such as the example refrigerator appliance shown in FIG. 1.

FIG. 5 provides a close-up perspective view of a portion of the example liquid drain assembly shown in FIG. 4.

FIG. 6 provides a cross-sectional view of a combination vacuum release drain valve of a liquid drain assembly according to one or more example embodiments of the present disclosure.

FIG. 7 provides a close-up cross-sectional view of the combination vacuum release drain valve shown in FIG. 6.

FIG. 8 provides a perspective view of the combination vacuum release drain valve shown in FIG. 6 positioned within a vaporizer pan of a liquid drain assembly.

FIG. 9 provides a partially exploded perspective view of the combination vacuum release drain valve shown in FIG. 6, particularly illustrating a first embodiment of a coupling arm of the combination vacuum release drain valve.

FIG. 10 provides a close-up perspective view of the first embodiment of the coupling arm of the combination vacuum release drain valve shown in FIG. 9.

FIG. 11 provides a partially exploded perspective view of the combination vacuum release drain valve shown in FIG. 6, particularly illustrating a second embodiment of a coupling arm of the combination vacuum release drain valve.

The use of the same reference numbers in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Terms such as “inner” and “outer” refer to relative directions with respect to the interior and exterior of the refrigerator appliance, and in particular the food storage chamber(s) defined therein. For example, “inner” or “inward” refers to the direction towards the interior of the refrigerator appliance. Terms such as “left,” “right,” “front,” “back,” “top,” or “bottom” are used with reference to the perspective of a user accessing the refrigerator appliance. For example, a user stands in front of the refrigerator to open the doors and reaches into the food storage chamber(s) to access items therein.

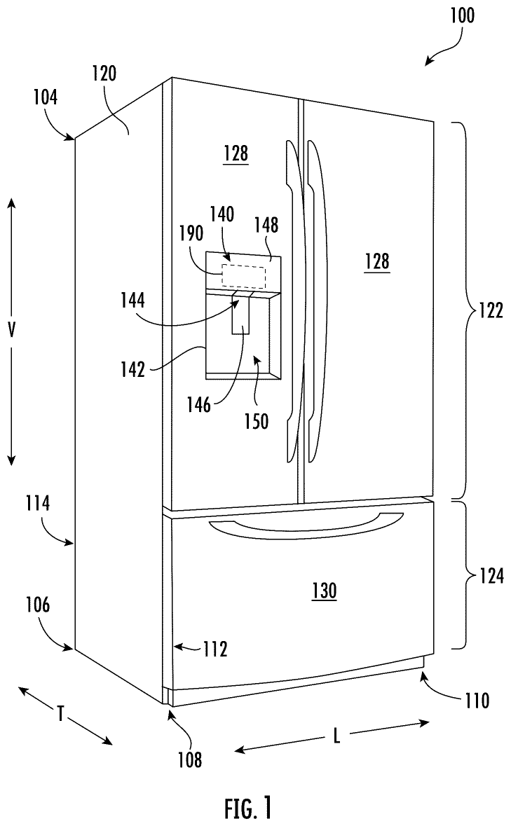

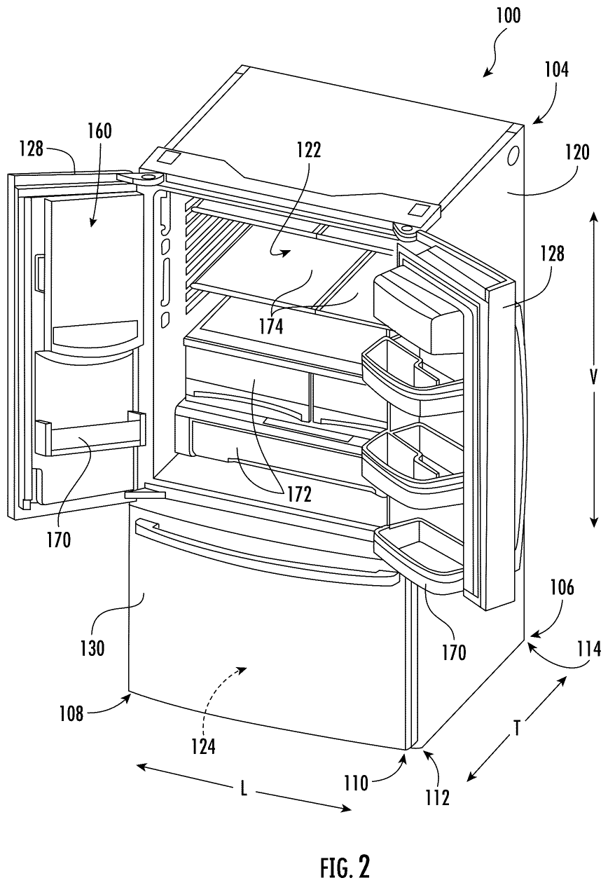

Turning now to the figures, FIG. 1 provides a perspective view of a refrigerator appliance 100 according to an example embodiment of the present disclosure. FIG. 2 provides another perspective view of refrigerator appliance when one or more doors 128, 130 are open. Refrigerator appliance 100 includes a cabinet or housing 120 that extends between a top portion 104 and a bottom portion 106 along a vertical direction V, between a left side 108 and a right side 110 along a lateral direction L, and between a front side 112 and a rear side 114 along a transverse direction T. Each of the vertical direction V, lateral direction L, and transverse direction T are mutually perpendicular to one another and form an orthogonal direction system.

Housing 120 defines chilled chambers for receipt of food items for storage. In particular, housing 120 defines fresh food chamber 122 positioned at or adjacent top portion 104 of housing 120. Refrigerator appliance 100 also includes a freezer chamber 124 that is, for example, arranged at or adjacent bottom portion 106 of housing 120. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance or a side-by-side style refrigerator appliance, such as a built-in side-by-side style refrigerator appliance. Consequently, the description set forth herein is for illustrative purposes only and is not intended to be limiting in any aspect to any particular chilled chamber configuration.

Refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in a closed configuration in FIG. 1. As may be seen when refrigerator doors 128 are in the open configuration, e.g., as illustrated in FIG. 2, various storage components may be provided within one or both of the refrigerated chambers 122 and 124, such as bins 170, drawers 172, and/or shelves 174, in various combinations.

Refrigerator appliance 100 also includes a dispensing assembly 140 for dispensing liquid water and/or ice. Dispensing assembly 140 includes a dispenser 142 positioned on or mounted to an exterior portion of refrigerator appliance 100, e.g., on one of doors 128. Dispenser 142 includes a discharging outlet 144 for accessing ice and liquid water. An actuating mechanism 146, shown as a paddle, is mounted below discharging outlet 144 for operating dispenser 142. In alternative example embodiments, any suitable actuating mechanism may be used to operate dispenser 142. For example, dispenser 142 can include a sensor (such as an ultrasonic sensor) or a button rather than the paddle. A user interface panel 148 is provided for controlling the mode of operation. For example, user interface panel 148 includes a plurality of user inputs (not labeled), such as a water dispensing button and an ice-dispensing button, for selecting a desired mode of operation such as crushed or non-crushed ice.

Discharging outlet 144 and actuating mechanism 146 are an external part of dispenser 142 and are mounted in a dispenser recess 150. Dispenser recess 150 is positioned at a predetermined elevation convenient for a user to access ice or water and enabling the user to access ice without the need to bend-over and without the need to open doors 128. In example embodiments, dispenser recess 150 is positioned at a level that approximates the chest level of a user.

As shown, for instance in FIG. 2, at least one door 128 may include a door liner defining a sub-compartment, e.g., icebox compartment 160. Icebox compartment 160 extends into fresh food chamber 122 when refrigerator door 128 is in the closed position. Although icebox compartment 160 is shown in door 128, additional or alterative embodiments may include an icebox compartment defined within door 130. An ice making assembly or icemaker (not pictured) may be positioned or disposed within icebox compartment 160. Thus, ice may be supplied to dispenser recess 150 (see FIG. 1) from the icemaker and/or ice dispenser unit in icebox compartment 160 on a back side of refrigerator door 128.

Operation of the refrigerator appliance 100 can be generally controlled or regulated by a controller 190. Controller 190 may control or regulate various portions of refrigerator appliance 100 according to one or more discrete criteria. In other words, controller 190 may be configured to control refrigerator appliance 100, for example, according to one or more exemplary methods described herein and/or may be configured to perform some or all of such exemplary methods.

In some embodiments, controller 190 is operatively coupled to user interface panel 148 and/or various other components, as will be described below. User interface panel 148 provides selections for user manipulation of the operation of refrigerator appliance 100. As an example, user interface panel 148 may provide for selections between whole or crushed ice, chilled water, and/or specific modes of operation. In response to one or more input signals (e.g., from user manipulation of user interface panel 148 and/or one or more received sensor signals), controller 190 may operate various components of the refrigerator appliance 100 according to the current mode of operation.

Controller 190 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In some embodiments, the processor executes programming instructions stored in memory. For certain embodiments, the instructions include a software package configured to operate refrigerator appliance 100 and, e.g., execute an operation routine including one or more example methods described below. The memory may be a separate component from the processor or may be included onboard within the processor. Alternatively, controller 190 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 190, or portions thereof, may be positioned in a variety of locations throughout refrigerator appliance 100. In example embodiments, controller 190 is located within the user interface panel 148. In other embodiments, the controller 190 may be positioned at any suitable location within refrigerator appliance 100, such as for example within a fresh food chamber, a freezer door, etc. In additional or alternative embodiments, controller 190 is formed from multiple controllers or controller components mounted at discrete locations within or on refrigerator appliance 100. Input/output (“I/O”) signals may be routed between controller 190 and various operational components of refrigerator appliance 100. For example, user interface panel 148 may be operatively coupled to controller 190 via one or more signal lines or shared communication busses.

In some embodiments, controller 190 is operatively coupled to the various components of dispensing assembly 140 and may control operation of the various components. For example, the various valves, switches, etc. may be actuatable based on commands from the controller 190. As discussed, user interface panel 148 may additionally be operatively coupled to the controller 190. Thus, the various operations may occur based on user input or automatically through controller 190 instruction.

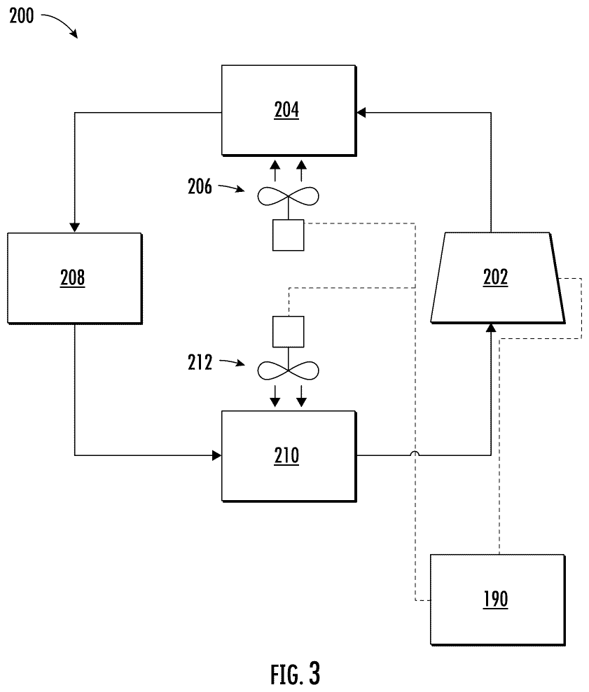

Referring now to FIG. 3, refrigerator appliance 100 may include a sealed refrigeration or cooling system 200. In general, sealed cooling system 200 is charged with a refrigerant that is flowed through various components and facilitates cooling of the fresh food chamber 122 and the freezer chamber 124. Sealed cooling system 200 may be charged or filled with any suitable refrigerant, such as R441A, R600a, R600, R290, etc.

Sealed cooling system 200 includes a compressor 202 for compressing the refrigerant, thus raising the temperature and pressure of the refrigerant. Compressor 202 may for example be a variable speed compressor 202, such that the speed of the compressor 202 can be varied between zero (0%) and one hundred percent (100%) by controller 190. Sealed cooling system 200 may further include a condenser 204, which may be disposed downstream of compressor 202, e.g., in the direction of flow of the refrigerant. Thus, condenser 204 may receive refrigerant from the compressor 202, and may condense the refrigerant by lowering the temperature of the refrigerant flowing therethrough due to, e.g., heat exchange with ambient air. A condenser fan 206 may be used to force air over condenser 204 as illustrated to facilitate heat exchange between the refrigerant and the surrounding air. Condenser fan 206 can be a variable speed fan-meaning the speed of condenser fan 206 may be controlled or set anywhere between and including, e.g., zero (0%) and one hundred percent (100%). The speed of condenser fan 206 can be determined, and communicated to condenser fan 206, by controller 190. Compressor 202 and/or condenser 204 may be positioned within or adjacent to a vaporizer pan, e.g., vaporizer pan 250 described below.

Sealed cooling system 200 further includes an evaporator 210 disposed downstream of the condenser 204. Additionally, an expansion device 208 (e.g., a capillary tube, electronic expansion valve, or other similar device) may be utilized to expand the refrigerant, and thus further reduce the pressure of the refrigerant, leaving condenser 204 before being flowed to evaporator 210. The evaporator 210 generally is a heat exchanger that transfers heat from air passing over the evaporator 210 to refrigerant flowing through evaporator 210, thereby cooling the air and causing the refrigerant to vaporize. An evaporator fan 212 may be used to force air over evaporator 210. As such, cooled air is produced and supplied to refrigerated chambers 122, 124 of refrigerator appliance 100. In certain embodiments, the evaporator fan 212 may be a variable speed evaporator fan-meaning the speed of evaporator fan 212 may be controlled or set anywhere between and including, e.g., zero (0%) and one hundred percent (100%). The speed of evaporator fan 212 may be determined by controller 190 and communicated to evaporator fan 212 by controller 190.

The evaporator 210 may be in communication with fresh food chamber 122 and/or with freezer chamber 124 to provide cooled air to one or both of chambers 122, 124. From the evaporator 210, refrigerant may flow back to and through compressor 202, which may be downstream of the evaporator 210, thus completing a closed refrigeration loop or cycle.

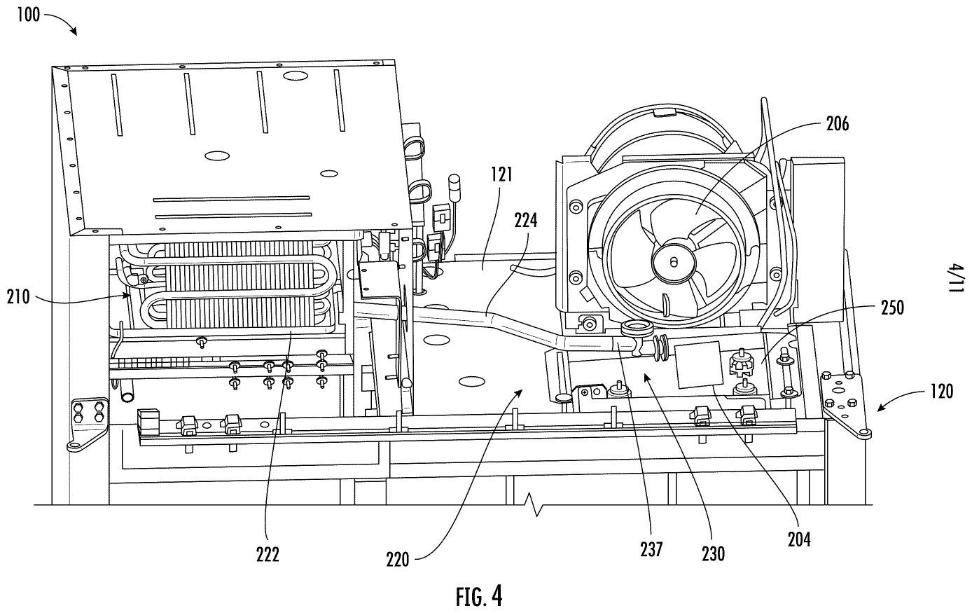

Referring now to FIGS. 4 through 11, views of various portions of a liquid drain assembly 220 of a refrigerator appliance are provided. As described herein, the liquid drain assembly 220 may be utilized with the refrigerator appliance 100. As such, the liquid drain assembly 220 may drain liquid, such as defrosted liquid, away from the evaporator 210 of the sealed cooling system 200 and contain the drained liquid to inhibit or prevent the liquid from contacting undesired components of the refrigerator appliance 100. However, while described herein as utilized with refrigerator appliance 100, it should be appreciated that the liquid drain assembly 220 may be used with various types of refrigerator appliances including, but not limited to, a top mount refrigerator appliance, a side-by-side style refrigerator appliance, e.g., built-in side-by-side style refrigerator appliance, and/or the like. For example, the liquid drain assembly 220 may be positioned atop a built-in side-by-side style refrigerator appliance and positioned behind a decorative panel.

Referring first specifically to FIGS. 4 through 7, portions of the liquid drain assembly 220 are described in detail. As best illustrated in FIG. 4, the liquid drain assembly 220 and at least a portion of the sealed cooling system 200 may be positioned above housing 120 of refrigerator appliance 100 in the vertical direction V. As such, one or more components of the sealed cooling system 200 and/or the liquid drain assembly 220 may be mounted to a top floor 121 of the housing 120. However, while described herein as being positioned above the housing 120, it should be appreciated that the sealed cooling system 200 and/or the liquid drain assembly 220 may be positioned at any other suitable location within the refrigerator appliance 100, such as below the housing 120.

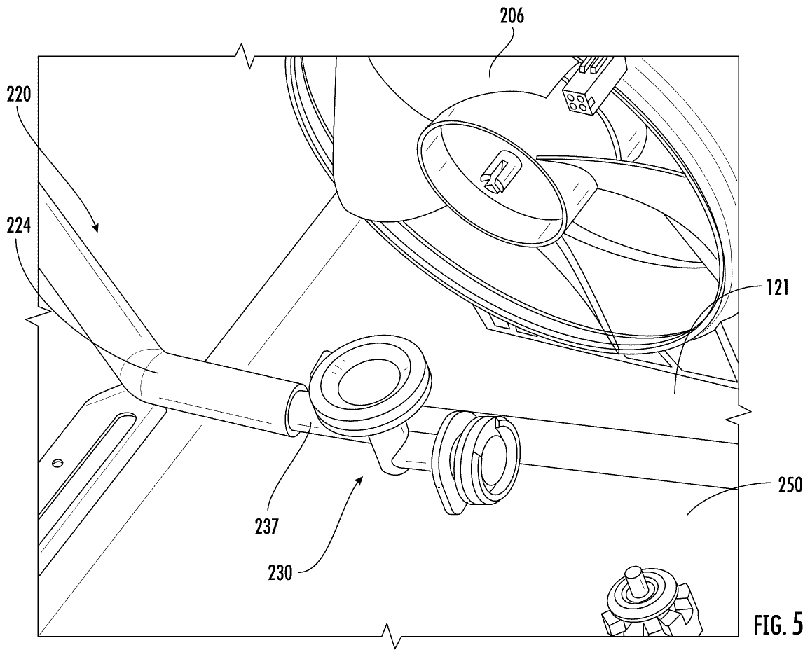

According to some example embodiments, an evaporator drip pan 222 of the liquid drain assembly 220 may be positioned directly below all or a portion of the evaporator 210 for capturing liquid dripping from the evaporator 210, particularly liquid that is defrosted from the evaporator 210 by a heater (not shown) during a defrosting process to maintain the efficiency of the sealed cooling system 200. Additionally, a tube 224 of the liquid drain assembly 220 may be fluidly coupled to a drain outlet (not shown) of the evaporator drip pan 222 at one end of the tube 224. As illustrated in FIGS. 4 and 5, the tube 224 may also be coupled to a combination vacuum release drain valve 230 of the liquid drain assembly 220, which will be described below, at a different end of the tube 224. The tube 224 provides a pathway for liquid to flow. Specifically, the liquid captured by the evaporator drip pan 222 may flow from the evaporator drip pan 222, through the tube 224, and into the combination vacuum release drain valve 230 from which it is selectively discharged, e.g., into a vaporizer pan 250 as will be described below. As such, the combination vacuum release drain valve 230 and the vaporizer pan 250 may be positioned below the evaporator drip pan 222 in the vertical direction V. In this respect, gravity may flow the liquid within the evaporator drip pan 222, into and through the tube 224, and into the combination vacuum release drain valve 230.

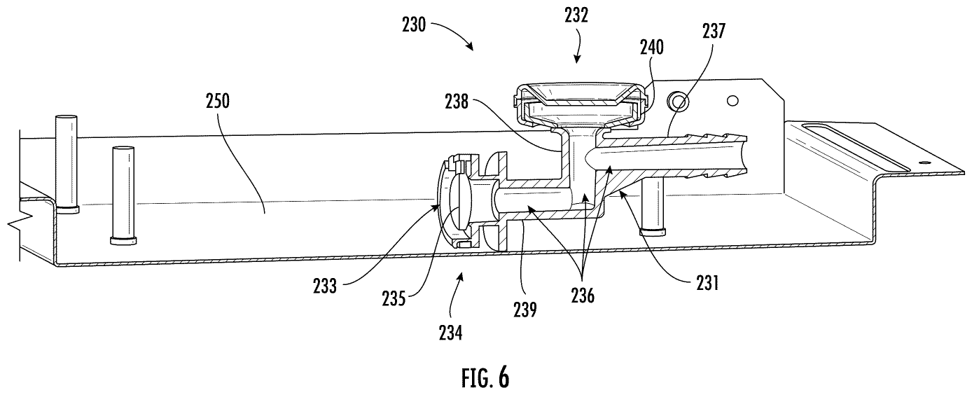

As best illustrated in FIG. 6, the combination vacuum release drain valve 230 includes a vacuum release valve 232 and a drain flapper valve 234 integrally coupled to each other or formed together, e.g., by molding. In this respect, the vacuum release valve 232 and the drain flapper valve 234 may be formed as a continuous piece, e.g., as a single continuous and monolithic piece forming a unitary body whereby the vacuum release valve 232 and the drain flapper valve 234 are integrally joined together without fasteners. As such, the vacuum release valve 232 and drain flapper valve 234 may not be fastened together, e.g., with screws, bolts, snap arms, and/or with any other type of fastener. Collectively, the vacuum release valve 232 and drain flapper valve 234 make up a portion of a main body 231 of the combination vacuum release drain valve 230.

According to some example embodiments, the combination vacuum release drain valve 230 includes one or more fluid passages, e.g., pipes, fluidly coupled together and that define a fluid pathway 236 within the combination vacuum release drain valve 230 and that, in combination with the vacuum release valve 232 and the drain flapper valve 234, make up the main body 231. Specifically, as illustrated in FIG. 6, the combination vacuum release drain valve 230 may include a first fluid passage 237, a second fluid passage 238, and a third fluid passage 239. The second fluid passage 238 may be integrally coupled or formed with the first fluid passage 237 and the third fluid passage 239. In this respect, the first fluid passage 237, the second fluid passage 238, and the third fluid passage 239 may be formed as a continuous piece, e.g., as a single continuous and monolithic piece forming a unitary body whereby the second fluid passage 238 is integrally joined together with the first fluid passage 237 and the third fluid passage 239 without fasteners. Collectively, the first fluid passage 237, the second fluid passage 238, and the third fluid passage 239 define the fluid pathway 236 within the combination vacuum release drain valve 230.

As best illustrated in FIGS. 4 and 5, the first fluid passage 237 may be directly and fluidly coupled to the tube 224 described above. In this respect, the liquid captured by the evaporator drip pan 222 may be received within the combination vacuum release drain valve 230 by the liquid flowing, by gravity, from the evaporator drip pan 222, through the tube 224, and into the first fluid passage 237 of the main body 231. After the liquid is received within the first fluid passage 237, it may flow into the second fluid passage 238, and then into the third fluid passage 239. Furthermore, the first fluid passage 237 may include an inlet with ribbing for receiving the tube 224, e.g., tube, thereon. The tube 224 may be removable from the first fluid passage 237 for maintenance. For example, the tube 224 may be replaced with new tubing and/or the combination vacuum release drain valve 230 may be removed for maintenance or replacement.

According to some example embodiments, the first fluid passage 237 and the third fluid passage 239 may extend or branch off from the second fluid passage 238. As illustrated in FIG. 6, in some embodiments, the first fluid passage 237 may extend from the second fluid passage 238 such that the first fluid passage 237 and the second fluid passage 238 are approximately perpendicular to each other. In this respect, a portion of the fluid pathway 236 that is defined by the first fluid passage 237 and a different portion of the fluid pathway 236 that is defined by the second fluid passage 238 are approximately perpendicular to each other. Additionally, or alternatively, in some embodiments, the third fluid passage 239 may extend from the second fluid passage 238 such that the third fluid passage 239 and the second fluid passage 238 are approximately perpendicular to each other. In this respect, a portion of the fluid pathway 236 that is defined by the third fluid passage 239 and the portion of the fluid pathway 236 that is defined by the second fluid passage 238 are approximately perpendicular to each other. Moreover, the first fluid passage 237 and the third fluid passage 239 may be approximately parallel to each other.

Additionally, or alternatively, in some example embodiments, the first fluid passage 237 and the third fluid passage 239 may be offset from each other. In this respect, the portion of the fluid pathway 236 that is defined by the first fluid passage 237 is offset from the portion of the fluid pathway 236 that is defined by the third fluid passage 239. For example, as illustrated in FIG. 6, the first fluid passage 237 may intersect the second fluid passage 238 above, in the vertical direction V, a location in which the third fluid passage 239 intersects the second fluid passage 238. The third fluid passage 239 may intersect the second fluid passage 238 at the bottom of second fluid passage 238. In this respect, the liquid that enters the first fluid passage 237 may flow along the first fluid passage 237, descend down the second fluid passage 238 in the vertical direction V, and then along the third fluid passage 239. The first fluid passage 237 may be positioned/spaced apart from the third fluid passage 239 as described above to inhibit or prevent noise created by turbulent liquid and/or disturbance of standing liquid within the fluid passages of the combination vacuum release drain valve 230. The disturbance of the liquid may be created/caused by air entering the fluid pathway 236.

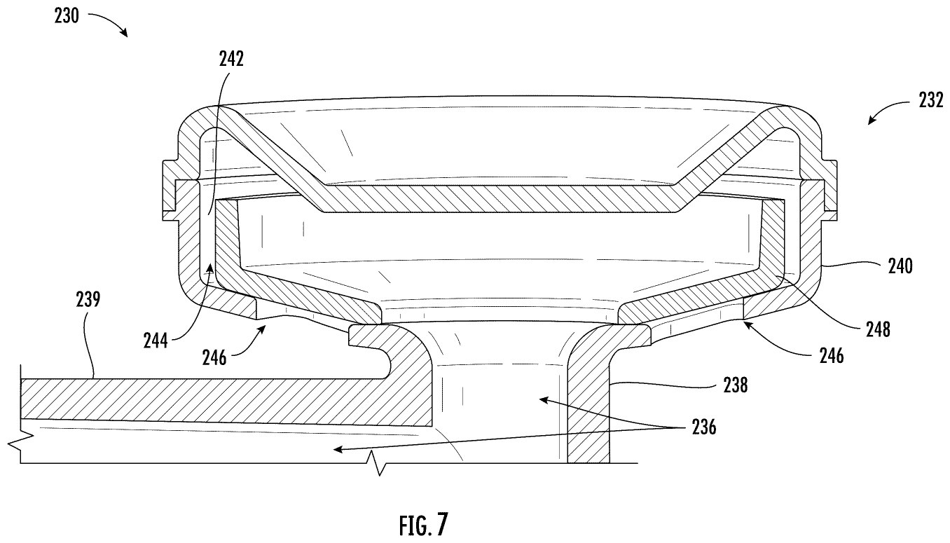

According to some exemplary embodiments, the vacuum release valve 232 of the combination vacuum release drain valve 230 includes a vacuum housing 240. The vacuum housing 240 may be fluidly coupled to/in fluid communication with one of the fluid passages of the main body 231. For example, in some embodiments, the vacuum housing 240 may be positioned at a top of the second fluid passage 238 and directly fluidly coupled to the second fluid passage 238 such that fluid, particularly air, may flow directly between the vacuum housing 240 and the second fluid passage 238. As best illustrated in FIG. 7, an interior surface 242 of the vacuum housing 240 defines a vacuum chamber 244. An inlet aperture 246 may be defined through the vacuum housing 240 and fluidly connect the vacuum chamber 244 with the environment that is external to the combination vacuum release drain valve 230. As such, air may pass through the inlet aperture 246 and directly into the vacuum chamber 244. From there, the air may flow into the second fluid passage 238, and subsequently the other fluid passages 237, 239, of the combination vacuum release drain valve 230.

Additionally, the vacuum release valve 232 includes one or more components for regulating the flow of air between an external environment surrounding the combination vacuum release drain valve 230 and the vacuum release valve 232 of the combination vacuum release drain valve 230. For example, in some example embodiments, the vacuum release valve 232 includes a diaphragm 248. The diaphragm 248 is positioned within the vacuum chamber 244 of the vacuum housing 240. The diaphragm 248 is configured to seal and unseal the inlet aperture 246 to permit and inhibit air from flowing into the vacuum chamber 244. Specifically, during typical operation when the air pressure externally of the combination vacuum release drain valve 230 and the air pressure within the combination vacuum release drain valve 230 are approximately the same, the weight of the diaphragm 248 moves/drops the diaphragm 248 to a closed position in which the diaphragm seals the inlet aperture 246 to inhibit or prevent air from entering the vacuum chamber 244 and to prevent air and/or liquid already within the combination vacuum release drain valve 230 from flowing backwards out of the combination vacuum release drain valve 230 and up the tubing 224. As such, the diaphragm 248 may move and, thus, air may enter the vacuum chamber 244 from outside of the combination vacuum release drain valve 230, when the air pressure externally of the combination vacuum release drain valve 230 is higher than the air pressure within the combination vacuum release drain valve 230.

Additionally, as best illustrated in FIG. 6, the drain flapper valve 234 of the combination vacuum release drain valve 230 may include a fluid passage that is in fluid communication with a fluid passage of the vacuum release valve 232. For example, in some exemplary embodiments, the third fluid passage 239, which may be part of the drain flapper valve 234, may be directly fluidly coupled to the second fluid passage 238, which may be part of the vacuum release valve 232 as described above. Furthermore, the fluid passage, e.g., the third fluid passage 239, of the drain flapper valve 234 may be integrally coupled to or formed together with the fluid passage, e.g., the second fluid passage 238, of the vacuum release valve 232.

Furthermore, as best illustrated in FIG. 6, in some example embodiments, the fluid passage of the drain flapper valve 234, e.g., the third fluid passage 239, may include an outlet 233, e.g., an opening or aperture, by which fluid, e.g., liquid and/or air, may be selectively discharged from the drain flapper valve 234 and, thus, the combination vacuum release drain valve 230. A flapper 235 may be positioned at the outlet 233. The flapper 235 may be configured to move between unsealed positions in which the flapper does not seal the outlet 233 and fluid is thus discharged from the combination vacuum release drain valve 230, and a sealed position in which the flapper 235 seals the outlet 233 to prevent or inhibit fluid from being discharged from the combination vacuum release drain valve 230. For example, the flapper 235 may be movable by the liquid within the combination vacuum release drain valve 230. Typically, the flapper 235 may “rest” or be naturally positioned in the sealed position. When sufficient liquid within the combination vacuum release drain valve 230 applies pressure or force to the flapper 235, the flapper 235 may move from the sealed position to one of the unsealed positions, thus selectively discharging the fluid from the combination vacuum release drain valve 230.

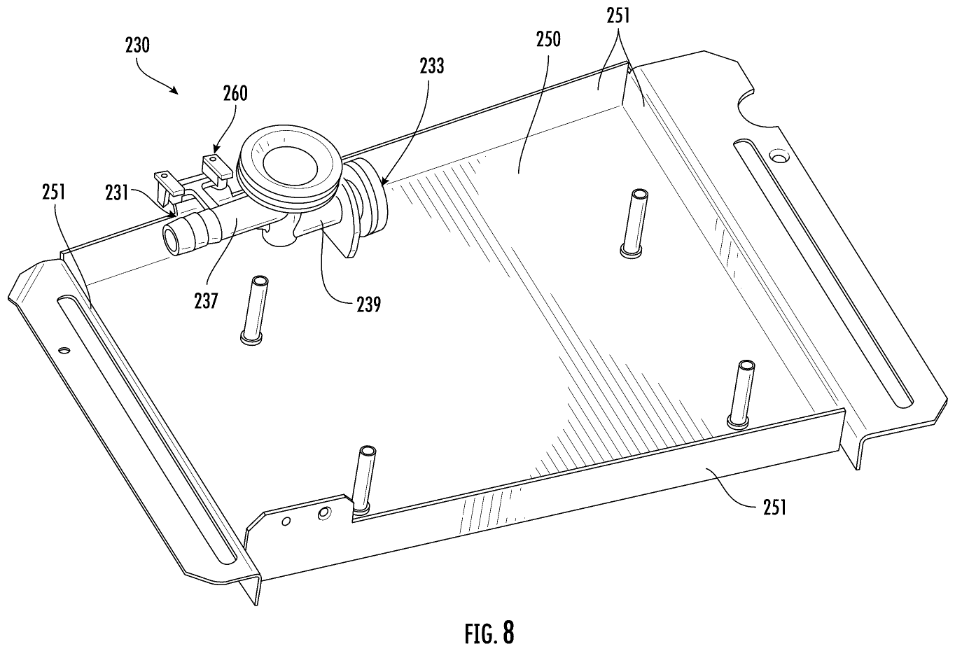

Now referring specifically to FIGS. 8 through 11, according to some example embodiments, the outlet 233 of the third fluid passage 239 of the combination vacuum release drain valve 230 may be positioned over the vaporizer pan 250. As such, liquid that is selectively discharged from the combination vacuum release drain valve 230 through the outlet 233 may be captured within the vaporizer pan 250. As illustrated in FIG. 8, the vaporizer pan 250 may include a plurality of vertically extending walls 251 for containing liquid therebetween. In some embodiments, the entire main body 231 of the combination vacuum release drain valve 230 may be positioned within the vaporizer pan 250, e.g., between the plurality of vertical extending walls 251.

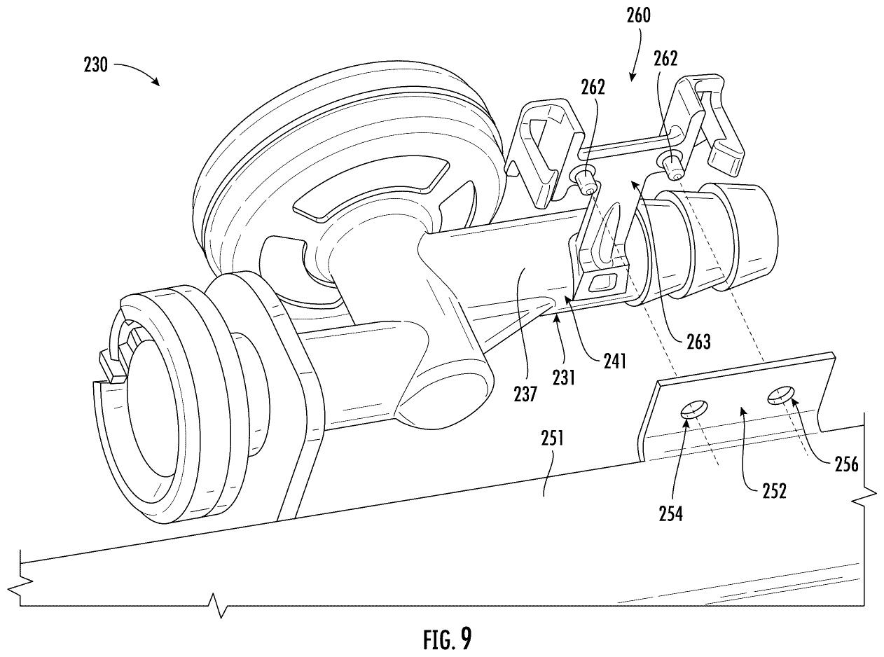

As best illustrated in FIGS. 9 through 11, according to some example embodiments, the combination vacuum release drain valve 230 includes a coupling arm 260 that is utilized for rigidly coupling the combination vacuum release drain valve 230. The coupling arm 260 may protrude from the main body 231. For example, in some embodiments, the coupling arm 260 may protrude from the first fluid passage 237, such as an exterior surface 241 of the first fluid passage 237. Additionally, the coupling arm 260 may be integrally coupled to the main body 231. In this respect, the coupling arm 260 and the main body 231 may be formed as a continuous piece e.g., as a single continuous and monolithic piece forming a unitary body whereby the coupling arm 260 and the main body 231 are integrally joined together without fasteners. Moreover, the coupling arm 260 is coupled to a portion of the vaporizer pan 250. For example, in some embodiments, the coupling arm 260 may be fastened to the portion of the vaporizer pan 250 as will be described below. Additionally, in some embodiments, the entire main body 231 of the combination vacuum release drain valve 230 may be positioned within the vaporizer pan 250, e.g., between the plurality of vertical extending walls 251, while rigidly coupled to the vaporizer pan 250 via the coupling arm 260. As such, movement of the combination vacuum release drain valve 230 may be constrained relative to the vaporizer pan 250, e.g., in six degrees of freedom as will be described below.

According to some example embodiments, one or more locating protuberances, e.g., such as locating cylinders/pins, walls, and/or the like, may protrude from the coupling arm 260 for locating the combination vacuum release drain valve 230 on the vaporizer pan 250. For example, as best illustrated in FIG. 9, in some embodiments, two locating pins 262 may protrude from an underside 263 of the coupling arm 260, e.g., vertically downward. The two locating pins 262 may be spaced apart from each other along the underside 263 and approximately parallel to each other. Furthermore, the vaporizer pan 250 may include a flange 252 with two apertures, a first aperture 254 and a second aperture 256, defined therethrough that correspond to the two locating pins 262. The two apertures 254, 256 may be spaced apart by approximately the same distance as the two locating pins 262 and may vertically receive the two locating pins 262 therethrough. The two apertures 254, 256 may bound/constrain the two locating pins 262 while the two locating pins 262 are received through the apertures 254, 256 and, thus, the combination vacuum release drain valve 230, in three degrees of freedom, e.g., in one of three rotational directions and in two of three linear directions.

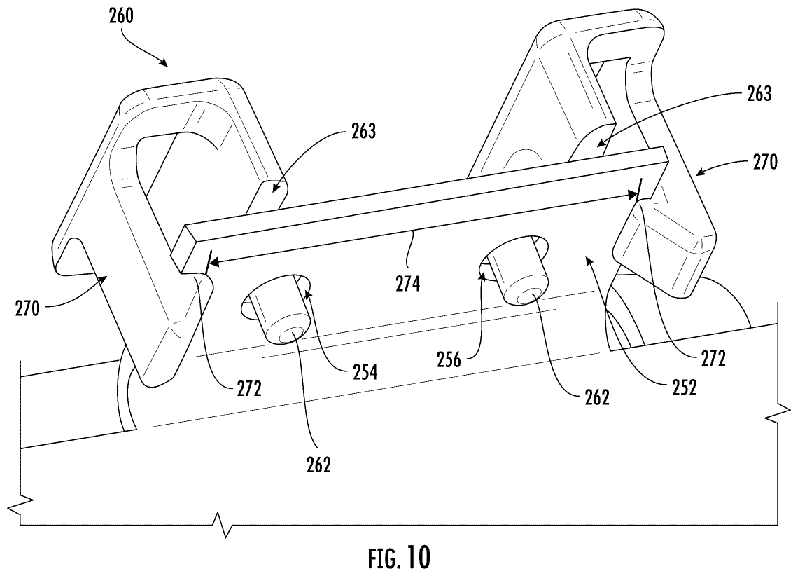

Furthermore, as best illustrated in FIGS. 9 and 10, the coupling arm 260 may include a pair of opposing snap arms 270. Each of the snap arms 270 may include a ridge 272 that is received over and “snapped” onto the flange 252 of the vaporizer pan 250. A gap 274 may be defined between the pair of opposing snap arms 270, e.g., the ridges 272 thereof, and the underside 263 of the coupling arm 260. While the coupling arm 260 is rigidly coupled to the flange 252, the flange 252 is sandwiched between the snap arms 270, which provide counteracting forces to hold the flange therebetween. The flange 252 is also sandwiched vertically between the snap arms 270, e.g., the ridges 272 thereof, and the underside 263. As such, in combination with the two locating pins 262 received within the apertures 254, 256 described above, the combination vacuum release drain valve 230 may be bounded/constrained in six degrees of freedom, e.g., three rotational directions and three linear directions.

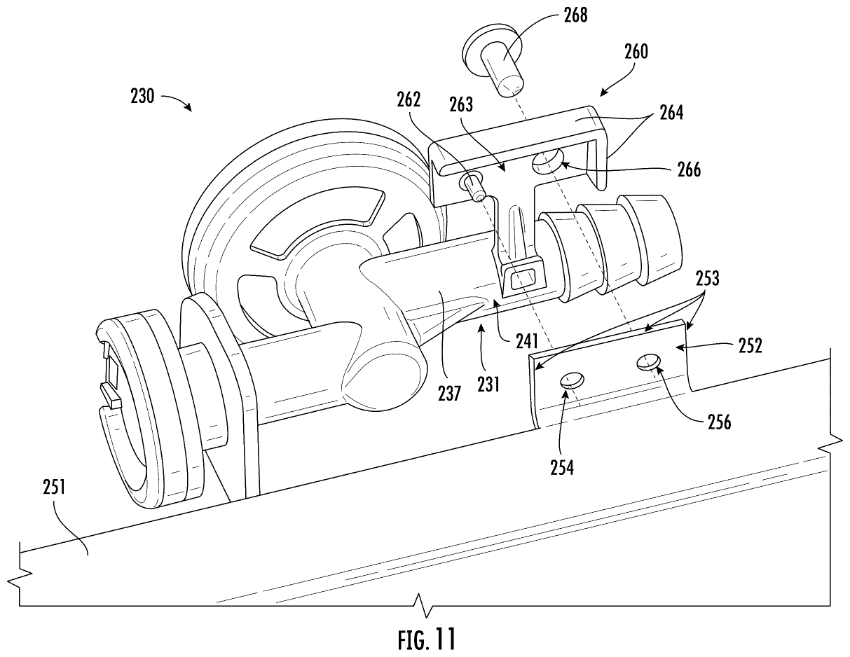

Additionally, or alternatively, as best illustrated in FIG. 11, in some embodiments, a single locating pin 262 and a locating wall 264 may protrude from the underside 263 of coupling arm 260, e.g., vertically downward. One of the two apertures, such as the first aperture 254, of the flange 252 of the vaporizer pan 250 may bound/constrain the single locating pin 262 while the single locating pin 262 is received through the first aperture 254. Additionally, while the single locating pin 262 is received through the first aperture 254, the locating wall 264 is positioned around a perimeter or edges 253 of the flange 252, such as around two or more vertically extending edges 253 of the flange 252. In this respect, the first aperture 254 and the locating wall 264 may bound/constrain the combination vacuum release drain valve 230 in three degrees of freedom, e.g., in one of three rotational directions and in two of three linear directions. Furthermore, a coupling arm aperture 266 may be defined through the coupling arm 260 and may be spaced apart from and approximately parallel to the single locating pin 262. In this respect, the first aperture 254 and the locating wall 264 may aid in locating the combination vacuum release drain valve 230 such that the second aperture 256 is aligned with the coupling arm aperture 266. While the second aperture 256 is aligned with the coupling arm aperture 266, a linear fastener 268, such as a rivet, bolt, and/or the like, may be received simultaneously therethrough and tightened to rigidly couple the coupling arm 260 to the vaporizer pan 250. Furthermore, once the coupling arm 260 has been coupled as such, the coupling arm 260 is constrained in six degrees of freedom, e.g., three rotational directions and three linear directions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, the refrigerator appliance defining a vertical direction, a lateral direction, and a transverse direction, the refrigerator appliance comprising:
a cabinet defining a chilled chamber;
a door rotatably hinged to the cabinet to provide selective access to the chilled chamber;
a sealed cooling system for providing cooled air into the chilled chamber, the sealed cooling system comprising an evaporator; and
a liquid drain assembly for the evaporator of the sealed cooling system, the liquid drain assembly comprising:
an evaporator drip pan positioned below the evaporator for capturing liquid dripping from the evaporator;
a combination vacuum release drain valve comprising a main body, the main body comprising a vacuum release valve and a drain flapper valve integrally coupled to each other; and
a tube fluidly coupled between the evaporator drip pan and the combination vacuum release drain valve, whereby fluid is permitted to flow from the evaporator drip pan to the combination vacuum release drain valve.

2. The refrigerator appliance of claim 1, wherein the vacuum release valve of the combination vacuum release drain valve comprises:
a vacuum housing including an interior surface that defines a vacuum chamber, an inlet aperture defined through the vacuum housing by which air enters the interior vacuum chamber;
a diaphragm positioned within the interior vacuum chamber of the vacuum housing, the diaphragm configured to seal the inlet aperture of the vacuum housing; and
a fluid passage extending below and in fluid communication with the vacuum housing, the fluid passage integrally coupled to a portion of the drain flapper valve.

3. The refrigerator appliance of claim 1, wherein the drain flapper valve of the combination vacuum release drain valve comprises:
a fluid passage in fluid communication with a fluid passage of the vacuum release valve, the fluid passage of the drain flapper valve integrally coupled to the fluid passage of the vacuum release valve; and
a flapper positioned at an outlet of the fluid passage of the drain flapper valve, the flapper configured to seal the outlet of the fluid passage of the drain flapper valve.

4. The refrigerator appliance of claim 1, the main body of the combination vacuum release drain valve further comprising:
a first fluid passage;
a second fluid passage; and
a third fluid passage,
wherein:
the second fluid passage is integrally coupled to and in fluid communication with the first fluid passage and the third fluid passage; and
the second fluid passage is approximately perpendicular to the first fluid passage and the third fluid passage.

5. The refrigerator appliance of claim 4, wherein:
the first fluid passage and the third fluid passage are offset from each other,
wherein, a fluid pathway defined within the first fluid passage is offset from a fluid pathway defined within the third fluid passage while the first fluid passage and the third fluid passage are offset from each other.

6. The refrigerator appliance of claim 4, wherein:
the second fluid passage is directly coupled to a vacuum housing of the combination vacuum release drain valve; and
a flapper is positioned at an outlet of the third fluid passage.

7. The refrigerator appliance of claim 1, wherein:
the liquid drain assembly further comprises a vaporizer pan separated from the evaporator and the evaporator drip pan, a condenser of the sealed cooling system positioned within the vaporizer pan;
the combination vacuum release drain valve further comprises a coupling arm integrally coupled to and protruding from the main body; and
the coupling arm is fastened to a portion of the vaporizer pan, whereby the combination vacuum release drain valve is rigidly coupled to the vaporizer pan.

8. The refrigerator appliance of claim 7, wherein:
the main body of the combination vacuum release drain valve is positioned within the vaporizer pan while rigidly coupled to the vaporizer pan.

9. The refrigerator appliance of claim 7, wherein:
the coupling arm protrudes from an exterior surface of a first fluid passage of a plurality of fluid passages of the combination vacuum release drain valve.

10. The refrigerator appliance of claim 7, wherein:
a locating protuberance protrudes from the coupling arm, the locating protuberance received within an aperture of a flange of the vaporizer pan.

11. The refrigerator appliance of claim 10, wherein:
the aperture of the flange is a first aperture;
the coupling arm comprises a locating wall positioned around edges of the flange while the locating protuberance is received within the first aperture; and
a coupling arm aperture is defined through the coupling arm, a fastener received through the coupling arm aperture and a second aperture of the flange.

12. The refrigerator appliance of claim 7, wherein:
the coupling arm comprises an underside and pair of opposing snap arms, a gap defined between the underside and the pair of opposing snap arms, a flange of the vaporizer pan sandwiched between the pair of opposing snap arms and the underside, whereby movement of the combination vacuum release drain valve relative to the vaporizer pan is inhibited.

13. A refrigerator appliance, the refrigerator appliance defining a vertical direction, a lateral direction, and a transverse direction, the refrigerator appliance comprising:
a cabinet defining a chilled chamber;
a door rotatably hinged to the cabinet to provide selective access to the chilled chamber;
a sealed cooling system for providing cooled air into the chilled chamber, the sealed cooling system comprising an evaporator and a condenser; and
a liquid drain assembly for the evaporator of the sealed cooling system, the liquid drain assembly comprising:
a vaporizer pan; and
a combination vacuum release drain valve, the combination vacuum release drain valve comprising a main body and a coupling arm integrally coupled to and protruding from the main body, the coupling arm fastened to a portion of the vaporizer pan, whereby the combination vacuum release drain valve is rigidly coupled to the vaporizer pan.

14. The refrigerator appliance of claim 13, the main body of the combination vacuum release drain valve further comprising:
a first fluid passage;
a second fluid passage; and
a third fluid passage,
wherein:
the second fluid passage is integrally coupled to and in fluid communication with the first fluid passage and the third fluid passage; and
the second fluid passage is approximately perpendicular to the first fluid passage and the third fluid passage.

15. The refrigerator appliance of claim 14, wherein:
the first fluid passage and the third fluid passage are offset from each other,
wherein, a fluid pathway defined within the first fluid passage is offset from a fluid pathway defined within the third fluid passage while the first fluid passage and the third fluid passage are offset from each other.

16. The refrigerator appliance of claim 14, wherein:
the second fluid passage is directly coupled to a vacuum housing of the combination vacuum release drain valve; and
a flapper is positioned at an outlet of the third fluid passage.

17. The refrigerator appliance of claim 13, wherein:
the coupling arm protrudes from an exterior surface of a first fluid passage of a plurality of fluid passages of the combination vacuum release drain valve.

18. The refrigerator appliance of claim 13, wherein:
a locating protuberance protrudes from the coupling arm, the locating protuberance received within an aperture of a flange of the vaporizer pan.

19. The refrigerator appliance of claim 18, wherein:
the aperture of the flange is a first aperture;
the coupling arm comprises a locating wall positioned around edges of the flange while the locating protuberance is received within the first aperture; and
a coupling arm aperture is defined through the coupling arm, a fastener received through the coupling arm aperture and a second aperture of the flange.

20. The refrigerator appliance of claim 13, wherein:
the coupling arm comprises an underside and pair of opposing snap arms, a gap defined between the underside and the pair of opposing snap arms, a flange of the vaporizer pan sandwiched between the pair of opposing snap arms and the underside, whereby movement of the combination vacuum release drain valve relative to the vaporizer pan is inhibited.
